(19) United States
(12) Patent Application Publication
(10) Pub. No.: US 2015/0213088 A1
(43) Pub. Date: Jul. 30, 2015

(54) METHOD AND APPARATUS FOR PROVIDING APPLICATIONS ASSOCIATED WITH LOCATION-BASED USER-INTERFACES

(71) Applicant: Nokia Corporation, Espoo (FI)

(72) Inventors: Dhaval Jitendra Joshi, Bangalore (IN); Pankaj Nathani, Gujarat (IN)

(21) Appl. No.: 14/421,424

(22) PCT Filed: Oct. 7, 2013
(86) PCT No.: PCT/FI2013/050969

§ 371 Date: Feb. 12, 2015

(30) Foreign Application Priority Data
Nov. 30, 2012 (IN) 5007/CHE/2012

(51) Int. Cl. G06F 17/30; G06F 3/0484

(52) U.S. Cl. CPC G06F 17/30442; G06F 3/0484; G06F 17/30554

(57) ABSTRACT

An approach is provided for causing, at least in part, a presentation of at least one instance of an application in at least one user interface element (605) of a location-based user interface (501). The at least one user interface element (605) may be presented in association with at least one representation of at least one point of interest (503) in the location-based user interface (501).

### BACKGROUND

Service providers and device manufacturers (e.g., wireless, cellular, etc.) are continually challenged to deliver value and convenience to consumers by, for example, providing compelling network services. One area of interest has been the development of location-based or map-based applications and services. For example, the location-based services include providing information, such as, name, address, contact information, and coordinates, associated with a point of interest. Accordingly, service providers and device manufacturers face significant technical challenges in providing devices and applications for providing various services within location-based applications.

### SOME EXAMPLE EMBODIMENTS

Therefore, there is a need for an approach for efficiently providing a location-based interface in which applications may be presented.

According to one embodiment, a method comprises determining at least one point of interest presented on a location-based user interface. The method also comprises causing, at least in part, a presentation of at least one instance of an application in at least one user interface element of the location-based user interface. The at least one user interface element is presented in association with at least one representation of the at least one point of interest in the location-based user interface.

According to another embodiment, an apparatus comprises at least one processor, and at least one memory including computer program code for one or more computer programs, the at least one memory and the computer program code configured to, with the at least one processor, cause, at least in part, the apparatus to determine at least one point of interest presented on a location-based user interface. The apparatus is also caused to, at least in part, a presentation of at least one instance of an application in at least one user interface element of the location-based user interface. The at least one user interface element is presented in association with at least one representation of the at least one point of interest in the location-based user interface.

According to another embodiment, a computer-readable storage medium carries one or more sequences of one or more instructions which, when executed by one or more processors, cause, at least in part, an apparatus to determine at least one point of interest presented on a location-based user interface. The apparatus is also caused to, at least in part, a presentation of at least one instance of an application in at least one user interface element of the location-based user interface. The at least one user interface element is presented in association with at least one representation of the at least one point of interest in the location-based user interface.

According to another embodiment, an apparatus comprises means for determining at least one point of interest presented on a location-based user interface. The apparatus also comprises means for causing, at least in part, a presentation of at least one instance of an application in at least one user interface element of the location-based user interface. The at least one user interface element is presented in association with at least one representation of the at least one point of interest in the location-based user interface. The at least one user interface element is presented in association with at least one representation of the at least one point of interest in the location-based user interface.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of causing a location-based user interface to be presented, according to one embodiment;

FIG. 2 is a diagram of the components of a UE 101 according to one embodiment;

FIG. 3 is a diagram of the components of the POI interface platform 103 according to one embodiment;

FIG. 4 is a flowchart of a process for causing a location-based user interface to be presented, according to one embodiment;

FIG. 5 is a diagram of a user interface utilized in the processes of FIG. 4, according to various embodiments;

FIGS. 6A and 6B are diagrams of user interfaces utilized in the processes of FIG. 4, according to various embodiments;

FIG. 7 is a diagram of a user interface utilized in the processes of FIG. 4, according to various embodiments;

FIGS. 8A and 8B are diagrams of user interfaces utilized in the processes of FIG. 4, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing a location-based interface in which applications may be presented are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “point of interest (POI)” and “geo-location” may be used interchangeably. According to some embodiments of the present invention, where a certain POI may be a certain entity (e.g., a building, a retailer, a restaurant, any business establishment, etc.) at a certain geo-location and/or a geo-location may be a POI (e.g., an intersection at a given city, a street, an airport, etc.).

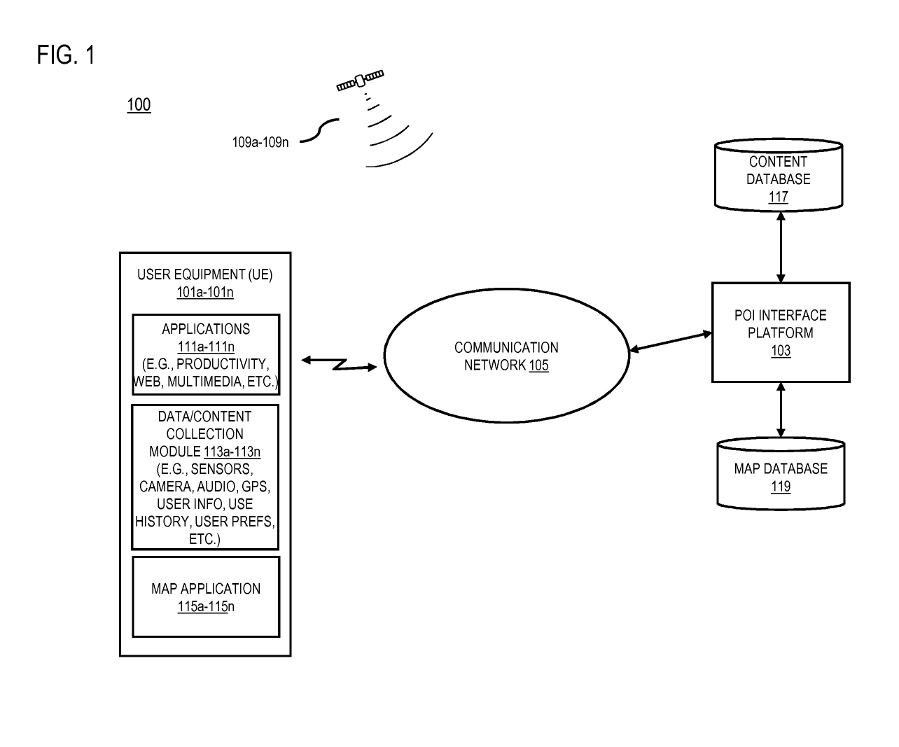

FIG. 1 is a diagram of a system capable of providing a location-based user interface in which at least one instance of an application may be caused to be presented, according to one embodiment. As previously discussed, one area of interest has been the development of services and technologies related to map applications. Generally, location-based applications, such as map applications, merely provide limited information (e.g., name, address, contact information, and coordinates) related to a point-of-interest and do not have the same level information that could be found on the World Wide Web. In many cases, the user wants to obtain additional information or perform additional services associated with and/or around the point-of-interest. To search for additional information or perform additional services, the user must switch between the map application and the other applications and perform the operations independently. For example, to obtain additional information associated with a point of interest, the user must close the map application, open a browser application to conduct a search and obtain the results, and then return to the map application to manually associate the information from the results with the details provided on the map application. Because this must be performed manually and require the user's short-term memory, the process can be time consuming and inefficient.

To address this problem, a system 100 of FIG. 1 introduces the capability for providing a location-based user interface in which at least one instance of an application may be caused to be presented. In some embodiments, the presentation of the at least one instance of an application may be in at least one user interface element of the location-based user interface. As used herein, “location-based user interface” refers to a user interface that presents a map image in two dimensions or three dimensions, receives input (e.g., criteria about the point of interest for which the user wishes to gather information), and displays search results. The criteria can include categories (e.g., restaurant, music store, sports store, park, park photographs etc.), names (e.g., The Compact Disc Shop, Central Park, Theme Park photographs, etc.), search region, or other keyword search terms.

As used herein, “user interface element” refers to an interface object (e.g., widget) configured to allow users to interact with the location-based user interface, for example, present information and provide access to other services, for example, an application. The user interface element may include components, for example, dialog boxes, icons, menus, or a combination thereof. It is contemplated that the functions of these components may be combined in one or more components or performed by other components of equivalent functionality. An application may include, at least in part, productivity applications (e.g. note taking applications), calendar applications, communication applications (e.g., messenger, email communications, etc.), browser applications (e.g., a version of Internet Explorer®, Bing®, Chrome®, Opera®, Safari®, etc.), social networking applications, multimedia applications, among others, or a combination thereof.

In this way, the system 100 can provide a unified user experience, i.e., the user can have immediate access to at least one application without leaving the location-based user interface. Additionally, the system 100 can support user interfaces, for example, mobile phones, that are not capable of multi-tasking.

In one embodiment, the at least one application may include a browser application supporting, at least in part, a local search, a generic search, or a combination thereof. A local search may include supporting a search around the point of interest and/or within the point of interest. For example, a search around the point of interest may include, at least in part, a search relating to an area around the point of interest (e.g., hyper-local search). A search within the point of interest may include at least in part, a search related to a point of interest (e.g., address, hours, parking information, contact information, reservation information, etc.). This search, for example, may include search the web address of the entity associated with the point of interest. In some embodiments, the browser application may use the location information (e.g., geo-location) of the point of interest from the location-based application to provide more targeted results.

In some embodiments, the user interface element may present more than one browser application. In this way, a user has the option to choose the browser that he/she would like to use with the location-based user interface. In some embodiments, the user may also have the option to choose the data network connection (e.g., WiFi or mobile data connection) for each browser and/or all browsers. The user may be able to choose permanently (e.g., saved to user settings (e.g., user preference information)) or temporarily (e.g., for that specific search). In some embodiments, each browser application may be presented with search results (e.g., number of results, a predetermined number of results, etc.).

In some embodiments, the system 100 causes, at least, a presentation of at least one application in the at least one user interface element based, at least in part, on user preference information, preference information from one or more entities associated with the at least one point of interest, or a combination thereof. In some embodiments, content items of the at least user interface element to be presented and/or data network connection may be based, at least in part, on user preference information, preference information from one or more entities associated with the at least one point of interest, or a combination thereof. The content items, may include, at least in part, the application(s), appearance scheme of the user interface element, content information, static operations (e.g., show route, landmarks, etc.), or a combination thereof to present. In this way, the at least one user interface element may be customized by the user and/or one or more entities associated with the point of interest. For example, an entity may tailor the appearance scheme of the at least one user interface element to correspond to the entity's color(s), the content to include specific news, such as relevant offers and/or discounts, among others, or a combination thereof.

In some embodiments, user preference information may include, at least in part, permanent or temporary settings for the location-based user interface. The settings may include the data network connection (e.g., WiFi or mobile data connection). In this way, for example, the browser application to be presented in the at least one user interface element and/or the data network connection may be based on user preference.

In some embodiments, the at least one point of interest may be presented on a location-based user interface. In some embodiments, the at least one point of interest may overlap a map image of the location-based user interface. In some embodiments, the at least one of point of interest may be marked, for example, by tagging, a map image of the location-based user interface. In some embodiments, the presentation of the at least one user interface element may also overlay a map image. In some embodiments, the presentation of the at least one user interface element be disposed adjacent to the associated at least one point of interest.

In some embodiments, the presentation of the at least one user interface element may be configured to dynamically changeable with respect to the location-based user interface. For example, the at least one user interface element may be configured to change appearance, for example, by changing color (e.g., a semi-light grey), changing size (e.g., minimized), etc. In some embodiments, the presentation of the at least one user interface element may be configured to be movable with respect to the location-based user interface. For example, the at least one user interface element may be configured to be hidden, moved to the side of the location-based user interface, etc. In this way, the at least one user interface element associated with the point of interest may not crowd the location based user interface, for example, so as to block the user seeing the other point of interests, etc., on the location-based user interface.

In some embodiments, the system 100 causes, at least in part, the at least one user interface element to be presented in a 2D and/or 3D interface. For example, for a building having multiple floors on which point of interests may be located, the user interface element may be represented as a multi-level building.

In some embodiments, the system 100 can learn from the user's searches and embed related information into the at least user interface element associated with the point of interest. In some embodiments, the system 100 can create user interface elements for a point of interest based on the context of a user search queries, for example, if the point of interest was not provided in a database.

As shown in FIG. 1, the system 100 comprises a user equipment (UE) 101a-101n (also collectively referred to as UE 101 and/or UEs 101) having connectivity to a point of interest (POI) interface platform 103 via a communication network 105. The UEs may be utilized to execute a map applications 115a-115n (also collectively referred to as map application 115 or map applications 115) and/or one or more other applications 111a-111n (also collectively referred to as application 111 or applications 111) including social networking applications, browser applications, productivity applications, multimedia applications, etc. to communicate with other UEs 101, the POI interface platform 103, and/or with other components of the system 100 directly and/or via communication network 105. In one embodiment, the UEs 101 may include data/content collection modules 113a-113n (also collectively referred to as DC collection module 113) for determining and/or collecting data and/or content associated with the UEs 101, one or more users of the UEs 101, the map application 115, the other applications 111, one or more content items (e.g., multimedia content), and the like.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). Further, the UEs 101 may include a data/content collection module 113 that include various sensors for collecting data associated with a user, a user's environment, and/or with a UE 101, for example, the sensors may determine and/or capture audio, video, images, atmospheric conditions, device locations, user mood, ambient lighting, device movement speed and direction, and the like.

In one embodiment, the data/content collection module 113 includes a location module/sensor, that can determine the UE 101 location (e.g., a user's location). The UE 101 location may be determined by a triangulation system such as a GPS, assisted GPS (A-GPS), Cell of Origin, wireless local area network triangulation, or other location extrapolation technologies. Standard GPS and A-GPS systems can use the one or more satellites 109 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module/sensor may also utilize multiple technologies to detect the location of the UE 101. GPS coordinates can provide finer detail as to the location of the UE 101. In another embodiment, the UE 101 may utilize a local area network (e.g., LAN, WLAN) connection to determine the UE 101 location information, for example, from an Internet source (e.g., a service provider).

In one embodiment, the POI interface platform 103 may include and/or have access to one or more database 117, which may store, include, and/or have access to content items, various user information, user profiles, user preferences, one or more profiles of one or more user devices (e.g., device configuration, sensors information, etc.), and the like. Further, the POI interface platform 103 may conduct a search for content items, media items, information, coupons, and the like associated with one or more entities, POIs, geo-locations, and the like. For example, the POI interface platform 103 may store content items (e.g., at the database 117) provided by various entities, various users, various service providers, crowd-sourced content, and the like. In various embodiments, the POI interface platform 103 may sort, manage, store, and/or make the content items available based on various parameters, for example, geo-location information (e.g., of a submitter (e.g., entity), of a content item, of a requestor, of a POI, etc.), and the like. In various embodiments, the content items may be associated with an entity, an entity at a point of interest, and the like.

In one embodiment, a user may request information about a particular point of interest or geo-location, for example, to aid in a decision about whether to go to that area, or about what to do when in that area, for example. The user may input his query by way of a map application 115 into the UE 101. The UE 101 may communicate with the POI interface platform 103 that sends a dataset to the UE 101 having search results that may be illustrated on the location-based user interface of the map application 115 that provides the search results, for example, in a graphical manner. The map application 115 may communicate with the POI interface platform 103 that has information stored in the database 117 about a particular geo-location or point of interest, such as restaurants, hotels, shopping centers, bars, theatres, etc. A map database 119 may provide the stored information regarding the map data to the POI interface platform 103 for aggregation of results. The POI interface platform 103 may also communicate with a social networking service, or other types of online directory information to get names, addresses, telephone numbers, operating hours, photos, to obtain information about a location such as ratings, reviews, rankings etc. about the area and any items of interest that may be located within the search area.

In various embodiments, the map application 115 may operate on the UE 101 in cooperation with the applications 111 in connection with the POI interface platform 103 as an extensible feature, a web-service, an applet, a script, an object-oriented application, or the like to enable processing, analyzing, detecting, and the like, of content items (e.g., audio, video, image, text, etc.), metadata, and the like for presenting at least one user interface element and other processes and applications. Further, the POI interface platform 103 and the map application 115 may utilize one or more service application programming interfaces (APIs)/integrated interface, through which communication, media, content, and information (e.g., associated with users and services, content, POIs, bookmarks, etc.) may be shared, accessed and/or processed.

By way of example, the UE 101s and the POI interface platform 103, may communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the UEs 101 and the POI interface platform 103 may interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. It is also noted that the role of a client and a server is not fixed; in some situations a device may act both as a client and a server, which may be done simultaneously and/or the device may alternate between these roles.

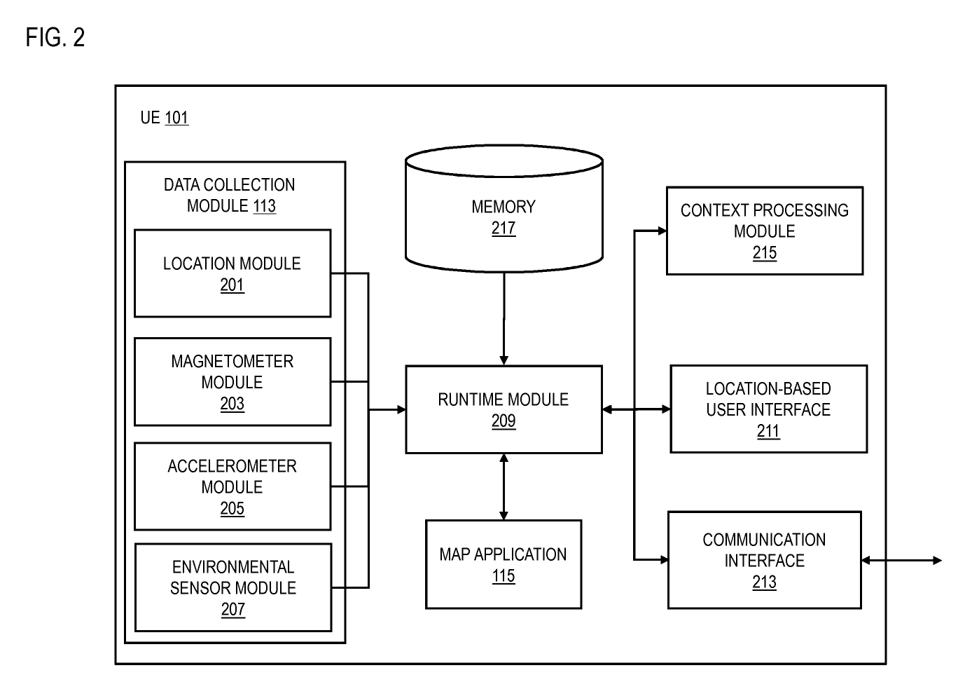

FIG. 2 is a diagram of the components of a user interface equipment capable of presenting a location-based user interface in which at least one instance of an application may be caused to be presented in at least one user interface element associated with a point of interest, according to one embodiment. By way of example, a UE 101 includes one or more components for providing a location-based user interface. It is contemplated that the functions of these components may be combined in one or more components or performed by other components of equivalent functionality. In this embodiment, the UE 101 includes a DC collection module 113 that may include one or more location modules 201, magnetometer modules 203, accelerometer modules 205, and sensors module 207. Further, the UE 101 may also include a runtime module 209 to coordinate the use of other components of the UE 101, the map application 115, a location-based user interface 211, a communication interface 213, a context processing module 215, and memory 217. The applications 111 of the UE 101 can also execute on the runtime module 209 utilizing the components of the UE 101.

The location module 201 can determine a user's location, for example, via location of a UE 101. The user's location can be determined by a triangulation system such as GPS, assisted GPS (A-GPS), Cell of Origin, or other location extrapolation technologies. Standard GPS and A-GPS systems can use satellites 109 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 217 and are available to the context processing module 215, the DC collection module 113, the map application 115, the location-based user interface 211, the POI interface platform 103, and/or to other entities of the system 100 (e.g., via the communication interface 213.) Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 217, made available to other modules and/or applications 111 of the UE 101, and/or transmitted via the communication interface 213 to one or more entities of the system 100.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In certain embodiments, the magnetometer module 203 and accelerometer module 205 can be means for ascertaining a perspective of a user. This perspective information may be stored in the memory 217, made available to other modules and/or applications 111 of the UE 101, and/or sent to one or more entities of the system 100.

In various embodiments, the sensors module 207 can process sensor data from various sensors (e.g., GPS, accelerometer, gyroscope, thermometer, etc.) to determine environmental (e.g., atmospheric) conditions surrounding the UE 101, location information, and various other information from a range sensors that may be available on one or more devices. For example, the sensors module 207 may detect conditions including humidity, temperature, geo-location, biometric data of the user, etc. Once again, this information can be stored in the memory 217 and sent to the context processing module 215 and/or to other entities of the system 100. In certain embodiments, information collected from the DC collection module 113 can be retrieved by the runtime module 209 and stored in memory 217, made available to other modules and/or applications 111 of the UE 101, and/or sent to one or more entities of the system 100.

In one embodiment, the communication interface 213 can be used to communicate with one or more entities of the system 100. Certain communications can be via methods such as an internet protocol, messaging (e.g., SMS, MMS, etc.), or any other communication method (e.g., via the communication network 105). In some embodiments, the UE 101 can send context information associated with the UE 101 to the POI interface platform 103 and/or to other entities of the system 100. In some embodiments, the UE 101 can send POI results associated with a POI inquiry to the POI interface platform 103, other UE 101, and/or to other entities of the system 100.

The location-based user interface 211 can include various methods of communication. For example, the location-based user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc.

The context processing module 215 may be utilized in determining context information from the DC collection module 113 and/or applications 111 executing on the runtime module 209. This information may be caused to be transmitted, via the communication interface 213, to the POI interface platform 103 and/or to other entities of the system 100. The context processing module 215 may additionally be utilized as a means for determining information related to the user, an instance of data, a value, a content item, an object, a subject, and the like. In certain embodiments, the context processing module 215 can infer higher level context information from the context data such as favorite locations, significant places, common activities, interests in products and services, POIs at various geo-locations, etc.

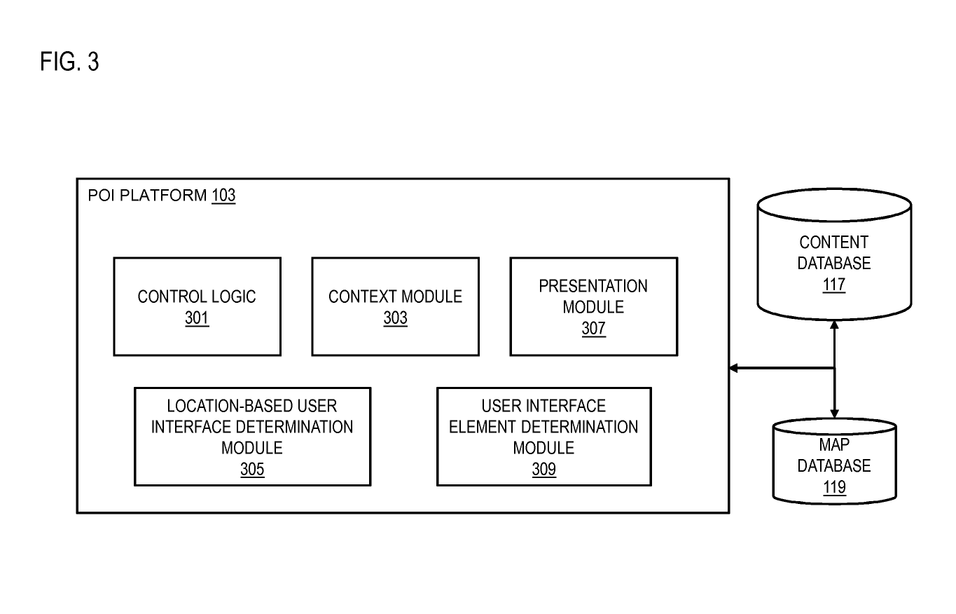

FIG. 3 is a diagram of the components of POI interface platform 103, according to one embodiment. By way of example, the POI interface platform 103 includes one or more components for providing expeditious rendering of results of a user query for point of interest information for a location-based user interface 211. It is contemplated that the functions of these components may be combined in one or more components or performed by other components of equivalent functionality. In this embodiment, the POI interface platform 103 includes a control logic 301, a context module 303, a location-based user interface determination module 305, a presentation module 307 and a user interface element determination module 309.

In this embodiment, the POI interface platform 103 includes at least a control logic 301 which executes at least one algorithm for executing functions of the POI interface platform 103. For example, the control logic 301 interacts with the context module 303 to determine context information for rendering a map image for the location-based user interface. The context information directs what type of map and what map objects are important to the map image. In one embodiment, the context module 303 communicates with the map database 119, the data/content collection module 113, the applications 111, the map application 115, the UE 101, or other component of the network 105 to determine context information. The context information may describe, for instance, an intended purpose of the map (e.g., tourist map, navigation map, hiking map, etc.), an environment for use of the map (e.g., walking, in a car, etc.), and the like for the location-based user interface.

The context module 303 may use a variety of mechanisms to determine the context information. In one mechanism, the context module 303 may receive direct input specifying a particular context. For example, a user may directly specify that the location-based user interface display a map of a particular city and overlay point of interest (e.g., restaurant) information on top of the map.

In yet another mechanism, the context module 303 may infer a context from the location of the requestor. For example, if a user requests a contextual map while located in a shopping center, the context module 303 may infer that the context of the map is related to shopping and will place a higher level of importance on points-of-interests related to shopping. Other indirect methods for determining context include, evaluating a recent history of online searches or recently viewed websites, evaluating recent communications (e.g., voice, text messages, and e-mails) for key words related to particular contexts, monitoring historical travel patterns or activities, or querying social networking services for context information. It is contemplated that any mechanism can be used by the context module 303 to determine context.

The context module 303 may then interact with the location-based user interface determination module 305 to determine the location-based user interface and/or at least one point of interest to present on the location-based user interface based on the determined context. The location-based user interface determination module 305 uses, for instance, semantic information to determine the importance or relevance of each point of interest to the context and classify the point of interests according the importance. By way of example, the location-based user interface determination module 305 retrieves metadata associated with each entity from the content database 117 and/or the map database 119. The metadata includes information, for example, the object's name, category (e.g., road, point of interest, water body, park, etc.), and location. The location-based user interface determination module 305 then performs a semantic analysis on the metadata to determine a level of association of the metadata for a point of interest with determined context, to determine at least one point of interest to present.

In one embodiment, the presentation module 307 interacts with map application 115 to present or cause, at least in part, actions that result in the presentation of a location-based user interface and/or at least one point of interest on a location-based user interface based on the ranking of the location-based user interface determination module 305. In particular, the presentation module 307 determines what point of interest(s) and the location user interface can be displayed on the UE 101 given the display area available on the UE 101.

In one embodiment, the user interface element determination module 309 receives the at least one point of interest to present and determines the content items of the user interface element to be associated with the points of interest on the location-based user interface to present. In one embodiment, the user interface element determination module 309 retrieves content items associated with each entity from the content database 117. The user interface element determination module 309 instructs the presentation module 307 to present and associate at least one user interface element with the point of interest on the location-based user interface.

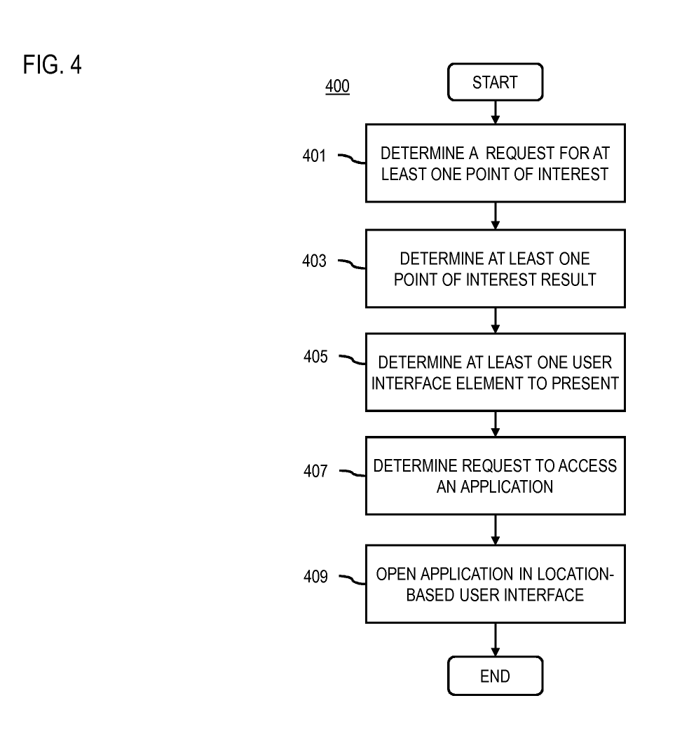

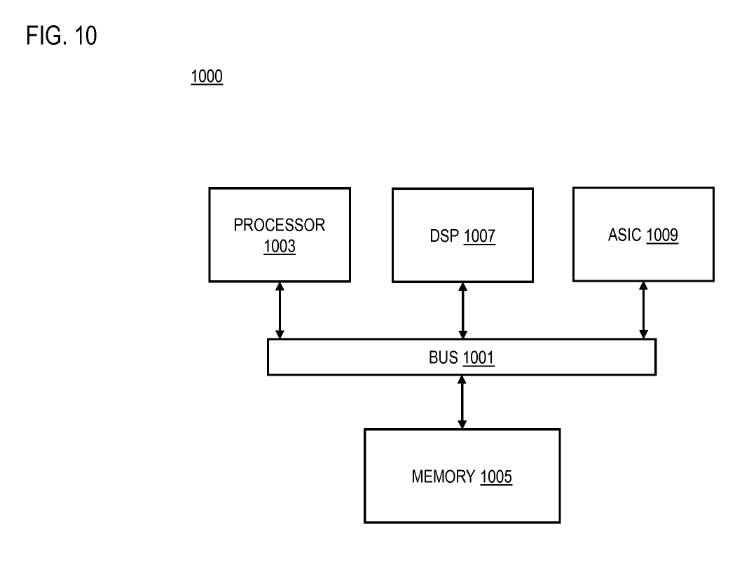

FIG. 4 is a flowchart of a process for causing a presentation of at least one instance of an application in at least one user interface element of a location-based user interface, according to one embodiment. In one embodiment, the POI interface platform 103 and/or the map application 115 performs the process 400 and is implemented in, for instance, a chip set including a processor and a memory as shown in FIG. 10. Further, the map application 115, the POI interface platform 103 and/or the UEs 101 can provide means for accomplishing various parts of the process 400 as well as means for accomplishing other processes in conjunction with other components of the system 100.

In step 401, the POI interface platform 103 processes and/or facilitates a processing to determine a request for point of interest. By way of example, a user may input his query by way of the map application 115 for a point of interest, for example, a restaurant located near an address.

Next, the POI interface platform 103 may determine at least one point of interest for an entity to present on a location-based user interface (step 403). The POI interface platform 103 may further determine at least one user interface element to be associated with at least one point of interest (step 405). In some embodiments, the point of interest may be presented with at least one user interface element. The content items, for example, color scheme and applications, and/or data network connection for the at least one user interface element may be based on user preferences, entity preferences, among others, or a combination thereof. In further embodiments, more than one point of interest may be presented with the same at least one user interface element.

Next, if the map application 115 determines that the user selects an application presented in the user interface element (step 407), the application opens in the location-based user interface (step 409). For example, if the user selects a browser application, the browser application opens in the location-based user interface.

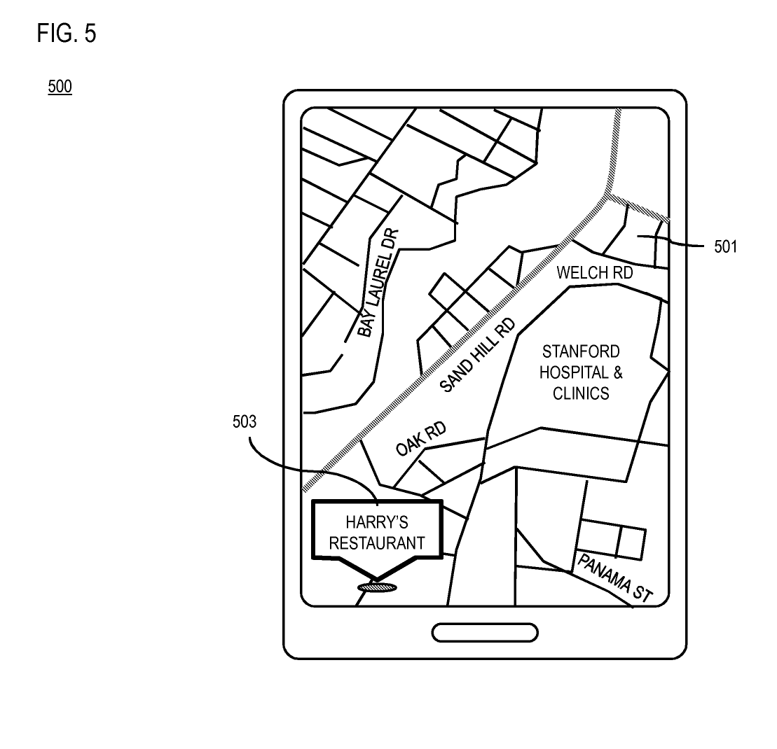

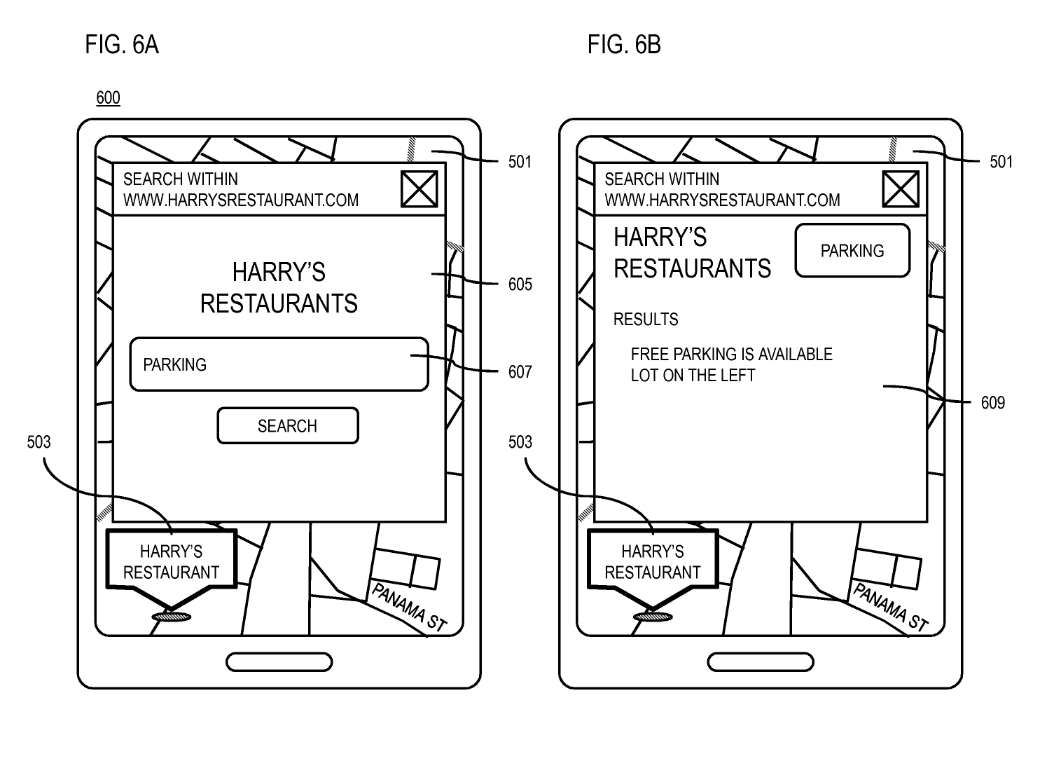

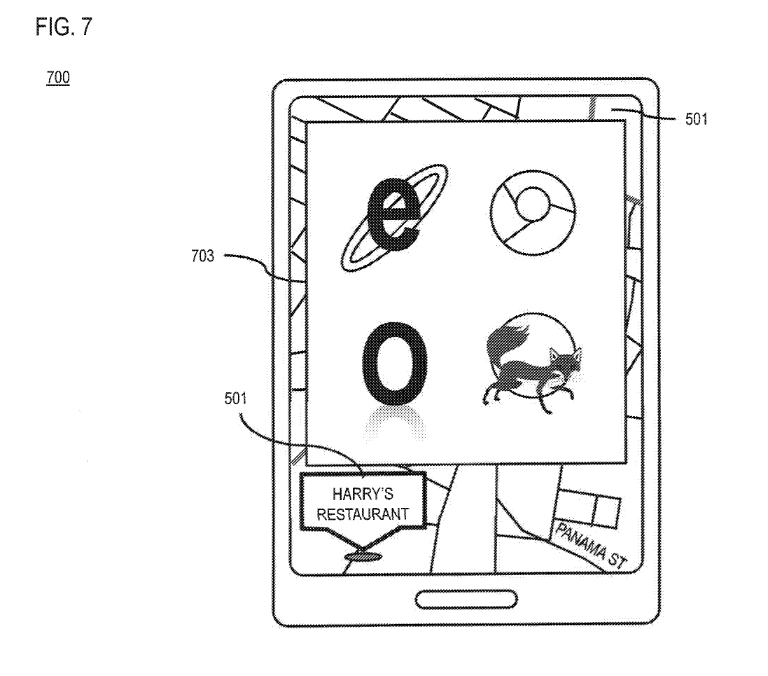

FIGS. 5, 6A-6B, 7, 8A, and 8B are diagrams of location-based user interfaces utilized in the processes of FIG. 4, according to various embodiments. In the examples of FIGS. 5, 6A-6B, 7, 8A, and 8B, a location based user interface 501 presented with a point of interest (result) 503. FIG. 5 illustrates the location-based user interface 501 presented with the point of interest 503, “Harry's Restaurant.” FIGS. 6A-6B, 7, 8A, and 8B illustrate examples of at least one user interface element associated with the point of interest 503, “Harry's Restaurant.” FIGS. 6A and 6B show an example of a local search. FIG. 6A shows an example of a user interface element 605 associated with the point of interest 503 configured for a local search. In this example, the user wants to conduct a search of the Harry's Restaurants' website to find more information about parking (e.g., query box 607). FIG. 6B illustrates an example of the user interface element 609 showing the results of the search query. FIG. 7 illustrates an example of a user interface element 705 associated with the point of interest 503, the user interface element 705 includes more than one browser application for selection by the user.

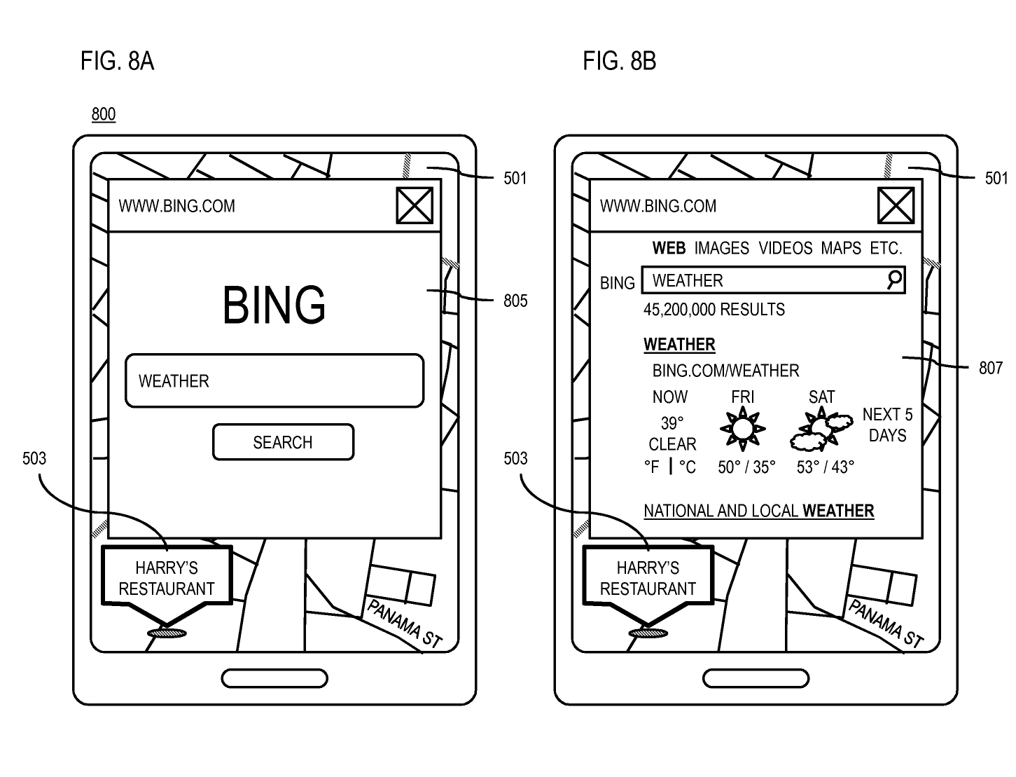

FIGS. 8A and 8B show an example of a generic search. FIG. 8A shows an example of a user interface element 805 associated with the point of interest 503 configured for a generic search. In this example, the user interface element 805 includes a browser application. The browser application can be presented based on the user and/or entity's preference or user's selection. Additionally, the data network connection (e.g., WiFi or mobile data plan) for the browser application may be based on the user's preference or user's selection. In this example, the user wants to conduct a search of the world wide web using the browser application to find out the weather local to the point of interest 503 is located. FIG. 8B illustrates an example of the user interface element 709 showing the results of the search query for weather.

The processes described herein for causing a presentation of at least one instance of an application in at least one user interface element of a location-based user interface may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

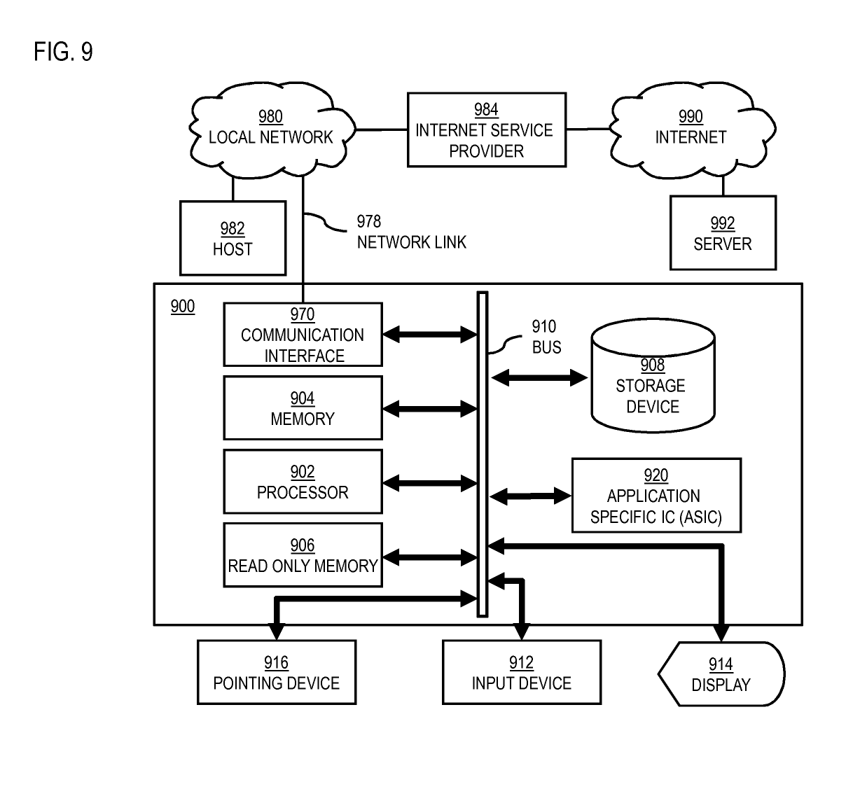

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of causing a presentation of at least one instance of an application in at least one user interface element of a location-based user interface.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to causing a presentation of at least one instance of an application in at least one user interface element of a location-based user interface. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for causing a presentation of at least one instance of an application in at least one user interface element of a location-based user interface. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for causing a presentation of at least one instance of an application in at least one user interface element of a location-based user interface, according to one embodiment, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for causing a presentation of at least one instance of an application in at least one user interface element of a location-based user interface to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to cause a presentation of at least one instance of an application in at least one user interface element of a location-based user interface, as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of causing a presentation of at least one instance of an application in at least one user interface element of a location-based user interface.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to cause a presentation of at least one instance of an application in at least one user interface element of a location-based user interface. The memory 1005 also stores the data associated with or generated by the execution of the inventive steps.

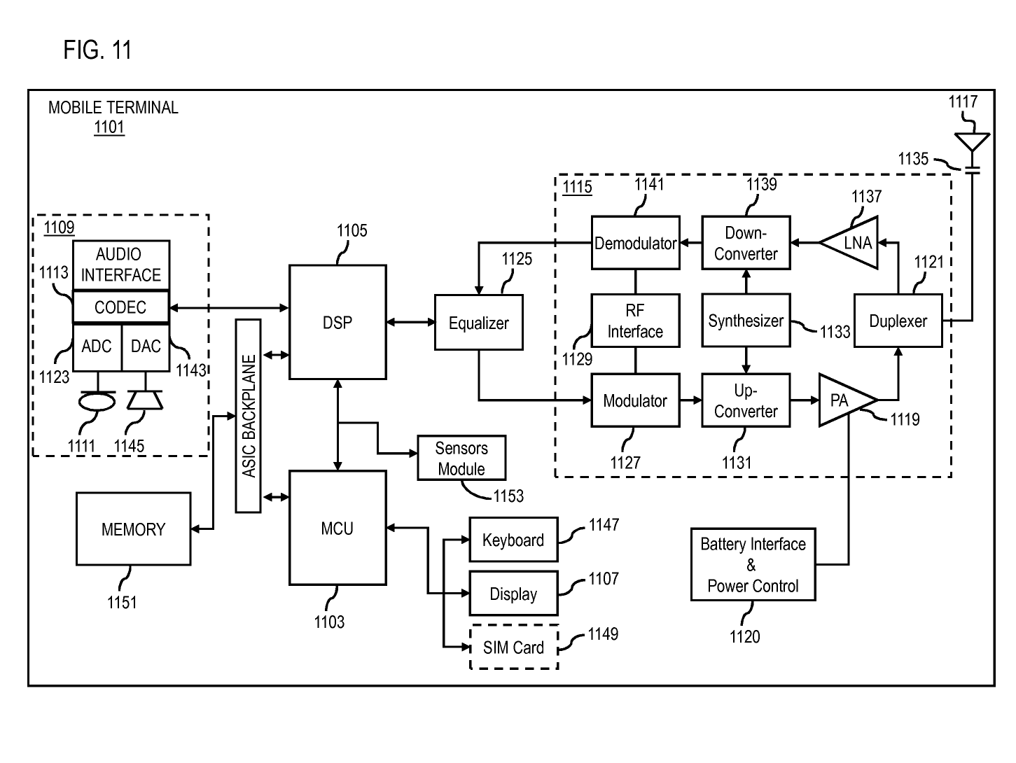

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of causing a presentation of at least one instance of an application in at least one user interface element of a location-based user interface. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of causing a presentation of at least one instance of an application in at least one user interface element of a location-based user interface. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to cause a presentation of at least one instance of an application in at least one user interface element of a location-based user interface. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. An apparatus comprising:
at least one processor; and
at least one memory including computer program code for one or more programs,
the at least one memory and the computer program code configured to, with the at least one processor, cause the apparatus to perform at least the following,
determine at least one point of interest presented on a location-based user interface; and
cause, at least in part, a presentation of at least one instance of an application in at least one user interface element of the location-based user interface,
wherein the at least one user interface element is presented in association with at least one representation of the at least one point of interest in the location-based user interface.

40. An apparatus of claim 39, wherein the application is a browser application supporting, at least in part, a local search, a generic search, or a combination thereof.

41. An apparatus of claim 40, wherein the apparatus is further caused to:
determine a search query inputted in the browser application; and
cause, at least in part, a presentation of results of the search query in the at least one user interface element.

42. An apparatus of claim 39, wherein the apparatus is further caused to:
determine the application to present in the at least one user interface element based, at least in part, on user preference information, preference information from one or more entities associated with the at least one point of interest, or a combination thereof.

43. An apparatus of claim 39, wherein the apparatus is further caused to:
determine at least one content item for the at least one user interface element to present and/or data network connection based, at least in part, on user preference information, preference information from one or more entities associated with the at least one point of interest, or a combination thereof.

44. An apparatus of claim 43, wherein the at least one content item include an application, appearance scheme, a static operation, content information, or a combination thereof.

45. An apparatus of claim 39, wherein the user interface element includes more than one browser application.

46. An apparatus of claim 39, wherein the least one user interface element is configured to be dynamically changeable with respect to the location-based user interface.

47. An apparatus of claim 39, wherein the at least one user interface element and the representation of the at least one point of interest overlay a map image.

48. A method comprising:
determining at least one point of interest presented on a location-based user interface; and
causing, at least in part, a presentation of at least one instance of an application in at least one user interface element of the location-based user interface,
wherein the at least one user interface element is presented in association with at least one representation of the at least one point of interest in the location-based user interface.

49. A method of claim 48, wherein the application is a browser application supporting, at least in part, a local search, a generic search, or a combination thereof.

50. A method of claim 49, further comprising:
determining a search query inputted in the browser application; and
causing, at least in part, a presentation of results of the search query in the at least one user interface element.

51. A method of claim 48, further comprising:
determining the application to present in the at least one user interface element based, at least in part, on user preference information, preference information from one or more entities associated with the at least one point of interest, or a combination thereof.

52. A method of claim 48, further comprising:
determining at least one content item for the at least one user interface element to present and/or data network connection based, at least in part, on user preference information, preference information from one or more entities associated with the at least one point of interest, or a combination thereof.

53. A method of claim 52, wherein the at least one content item include an application, appearance scheme, a static operation, content information, or a combination thereof.

54. A method of claim 48, wherein the user interface element includes more than one browser application.

55. A method of claim 48, wherein the least one user interface element is configured to be dynamically changeable with respect to the location-based user interface.

56. A method of claim 48, wherein the at least one user interface element and the representation of the at least one point of interest overlay a map image.

57. A computer program product including one or more sequences of one or more instructions which, when executed by one or more processors, cause an apparatus to at least perform the steps:
determining at least one point of interest presented on a location-based user interface; and
causing, at least in part, a presentation of at least one instance of an application in at least one user interface element of the location-based user interface,
wherein the at least one user interface element is presented in association with at least one representation of the at least one point of interest in the location-based user interface.

58. A computer program product of claim 57, wherein the application is a browser application supporting, at least in part, a local search, a generic search, or a combination thereof.
